(19) United States
(12) Patent Application Publication
(10) Pub. No.: US 2012/0011785 A1
(43) Pub. Date: Jan. 19, 2012

(54) Container Flooring

(75) Inventor: Marino Kulas, Concord (CA)

(73) Assignee: CONFORCE INTERNATIONAL, INC., Concord (CA)

(21) Appl. No.: 13/185,071

(22) Filed: Jul. 18, 2011

Related U.S. Application Data
(63) Continuation of application No. PCT/CA2009/001736, filed on Dec. 2, 2009.
(60) Provisional application No. 61/145,832, filed on Jan. 20, 2009.

(51) Int. Cl. E04F 15/00; B62D 25/20; E04C 2/22; E04G 23/02; E04B 1/38; E04C 2/20

(52) U.S. Cl. 52/177; 52/578; 52/309.1; 52/309.13; 52/741.1; 296/184.1

(57) ABSTRACT

A synthetic flooring module and method of fabricating the module are disclosed. The flooring module comprises an extruded floor member composed of a chemical resin material which is unaffected by the complications inherent with wood flooring. The flooring module has a profile adapted to provide for the maximum strength under significant compressive loads normally inherent in supporting forklifts used in, for example tractor trailer flooring. The profile of the floor module provides a plurality of spaced apart supports can figure to provide the compressive strength noted above while employing a minimal amount of resent material. The volume between the spaced apart supports has a channel configuration and a substantially C-shaped profile. The profile in combination with the resent employed and the overall configuration of the supports provides for a structure having properties which exceed the properties inherent with wood or other materials previously used in the art.

### CROSS REFERENCE TO RELATED APPLICATIONS

This application is a continuation of PCT Application No. PCT/CA2009/001736 filed Dec. 2, 2009 which claims priority from U.S. Provisional Application No. 61/145,832 filed on Jan. 20, 2009; the contents of which are incorporated herein by reference.

### TECHNICAL FIELD

The present invention relates to flooring for use in a container and more particularly, the present invention relates to a plastic (polymeric) flooring material for use in containers, trailers and vehicle bodies.

### BACKGROUND ART

It is well known in this area of technology that mobile containers and some vehicles have flooring affixed to the cross members of, for example, a support frame of the body. An example is a truck or tractor trailer bed. The existing material is typically tropical hardwood an example of which is Apitong wood. This material has been obviously used for many years, however, it is replete with limitations. Some of the limitations attributed to this material include a lack of resistance to oil absorption, odour absorption, water damage, microbial and insect attack if left chemically untreated as well as delamination.

These limitations translate into significant repair costs and also have an impact on the type of material that can be transported in containers having wood flooring. As an example, such flooring does not permit consistent transportation of food where the food must be transported in a food grade environment. As a further limitation, many times, the containers require decontamination with chemical agents which, of course, exacerbates the ability to transport certain foodstuffs or other materials requiring a contaminant free environment.

Unfortunately, the wood flooring units also present a significant safety issue, mainly breakage in use. As is known, the flooring must withstand very significant compressive forces during loading/unloading which are concentrated loads such as forklift wheels, paper rolls, steel coils, etc. Generally speaking, forklifts have a mass of approximately 8000 Kilograms. Based on the structure of the forklift, a significant portion of the mass is concentrated in a localized area of the flooring and the enormous load is borne by the relatively small wheels inherent with forklift vehicles. This presents a concentrated force in a relatively small area on the wood container flooring and where there is no underlying steel cross member at that point, the wood must support the localized mass. This is results in a high probability for floor damage by the wheels. The result is breakage where the wheels sink through the wood. This obviously presents a very dangerous situation where the forklift, when under load, would tip over, or loose the lifting contents potentially damaging the goods being lifted, the forklift vehicle or worse the operator of the lift.

An additional limitation with wood flooring is realized by the breakage known above. In most situations, the breakage is contained to one area of the flooring, however, since the wood is in sheet form, a significant portion of the sheet, if not the whole sheet (depending upon location of damage) is effectively not reusable.

Other materials are known in this area of technology as a viable alternative for wood. Aluminium and steel have been employed to this end. Although the material provide for wholesale improvement over the resistance of wood, there are limitations with these. It is widely known that the aluminium and steel flooring does not provide any transparency for electromagnetic or radio frequency interference has poor electrical and thermal insulation. Finally, aluminum is exceedingly expensive relative to the wood alternative and steel corrodes. Further still, if the steel is not to warp and have concavities between the supports it must be more substantial dimensionally which inherently creates the possibility for weight penalties. Bamboo, although marketed as more environmental product, still requires chemical treatment for use in overseas shipping containers and as such disposal by way of landfill.

Bamboo is heavier than tropical hardwoods used previously and carries the weight penalty that are approximately 10% heavier than the tropical hardwoods in use. Bamboo also is susceptible to all the inefficiencies of wood. Various combinations of other woods in container plywood have demonstrated further weaknesses in load bearing capacities.

It would be most desirable to have a flooring unit which is reusable and which does not suffer from all of the limitations inherent in the prior art. The present invention satiates this need and provides a unique flooring module and method of synthesizing the module that is applicable for use in dry cargo overseas shipping containers, reefer containers, tractor trailer dry van bodies, tractor trailer refrigerated van bodies, truck van bodies, cube van bodies and utility trailers among others.

### INDUSTRIAL APPLICABILITY

The invention has applicability in the flooring industry and, particularly, industrial flooring.

### DISCLOSURE OF THE INVENTION

One object of the present invention is to provide an improved floor module and a method of forming such a module.

A further object of one embodiment of the present invention is to provide a flooring member, comprising: a unitary polymeric body having a top surface an underside, opposed edges and opposed sides; a plurality of spaced apart dependent supporting legs for contact with a substrate, each leg having a segment orthogonally disposed relative to the top surface, a contact surface at a terminal point of the segment, the surface for contacting the substrate in spaced relation to a point of connection with the underside, the segment merging to the point of connection in a concave radial disposition to form a point of contact wider than a width dimension of the segment. The amalgamation of the pultrusion process with a specific group of resins and the unique configuration of the flooring members results in an advanced flooring member which obviates the rather significant limitations of presently used systems.

Conveniently, the flooring according to the present invention does not lose any structural integrity when exposed to moist conditions. Further to this advantage, the flooring does not absorb residues, fluids or other contaminants and can simply be steamed for cleaning, rather than sanding as in the case of wood. In this manner, the present flooring will not delaminate under conditions where wood material clearly would.

The selection of the resin materials discussed herein together with the configuration of the flooring support surface cooperate to yield a material particularly well suited for use as a flooring replacement for wood, steel, aluminum, etc. The use of a pultrusion process for commingling the support fibres with the polymer further augments the effectiveness of the overall product.

Since wood absorbs moisture, this presents a problem in respect of additional weight which attracts weight penalties. The flooring of the instant invention does not have any absorption characteristics.

Another object of another embodiment of the present invention is to provide a container, comprising, in combination: a body having a top, spaced apart sides, a back and a front spaced there from and an open bottom having support means in transverse relation relative to the sides, at least one of the sides, back and front being movable to permit access to the container; and a flooring member having a unitary polymeric body with a top surface an underside, opposed edges and opposed sides; a plurality of spaced apart dependent supporting legs for contact with the support means, each the leg having a segment orthogonally disposed relative to the top surface, a contact surface at a terminal point of the segment, the surface for contacting the support means in spaced relation to a point of connection with the underside, the segment merging to the point of connection in a concave radial disposition to form a point of contact wider than a width dimension of the segment, the flooring member being attached thereto.

The container may comprise any container designed to support a floor. An example is a shipping container for transporting goods on land and aboard a transport vessel. Such containers are fabricated by the CIMC company.

One of the most favourable features of the flooring according to the present invention is the durability. The presently disclosed flooring members do not have the mechanical limitations of aluminum or wood flooring and therefore outperform and outlast these materials. This feature is complemented by a significant weight reduction relative to comparable existing flooring materials.

Since the instant flooring members are composed of synthetic material, there is no continuous demand for bauxite, iron or wood to prepare new flooring units as would be the case in existing systems. Continuous use of these resources has environmental implications in terms of renewable resources and pollution for metal processing.

A still further object of one embodiment of the present invention is to provide the container with flooring attached to a vehicle.

Having thus generally described the invention, reference will now be made to the accompanying drawings illustrating preferred embodiments.

### BRIEF DESCRIPTION OF THE DRAWINGS

FIG. 1 is a schematic illustration of a conventional flatbed semi trailer with the flooring according to the present invention attached thereto;

FIG. 2 is a top partially cut away view of FIG. 1;

FIG. 3 is a is a cross sectional view of one embodiment of the present invention;

FIG. 3A is an enlarged view of one of the supporting legs of the flooring member;

FIG. 3B is an enlarged view of one of the edge of the of the flooring member; and

FIG. 4 is a schematic illustration of the flooring in situ on a flatbed semi trailer with a shipping container;

FIG. 5 is bottom view of a connection member according to the present invention connecting adjacent floor sections;

FIG. 6 is a top view of the flooring members as positioned on a supporting structure; and

FIG. 7 is a sectional view along line 7-7 in FIG. 6.

Similar numerals employed in the drawings denote similar elements.

### MODES FOR CARRYING OUT THE INVENTION

As a preface, the flooring member discussed herein is preferably formed by pultrusion. Those skilled in the art appreciate that the process involves pulling an array of fibres in the form of roving, tow, mat or fabric through a bath of resin and subsequently through a heated die to cure the resin. A saw may be programmed to cut the product to the desired length. Considering that the predominant fibre direction is usually longitudinal, advantages accrue in the properties of the resultant products in the form of high strength and stiffness in tension and bending. Accordingly, the process provides for ideal properties for synthesizing flooring which typically experiences tremendous compressive force and tough wear concomitant with shipping materials.

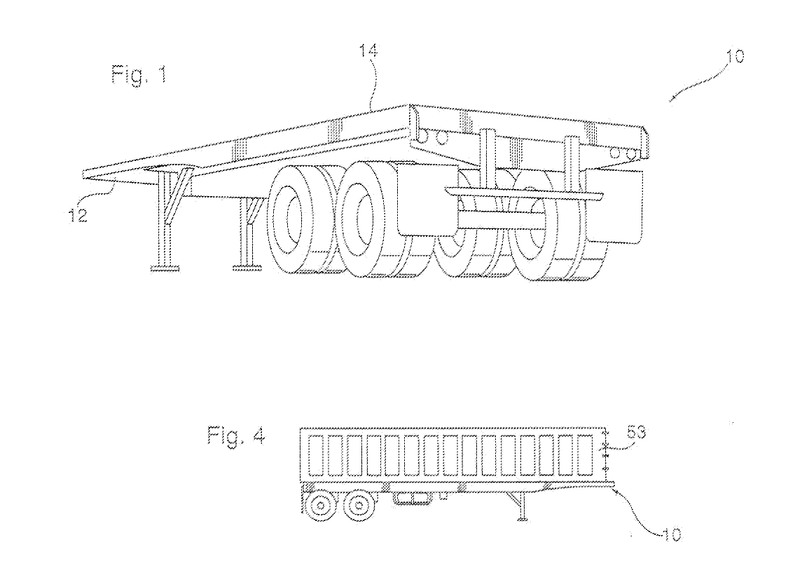

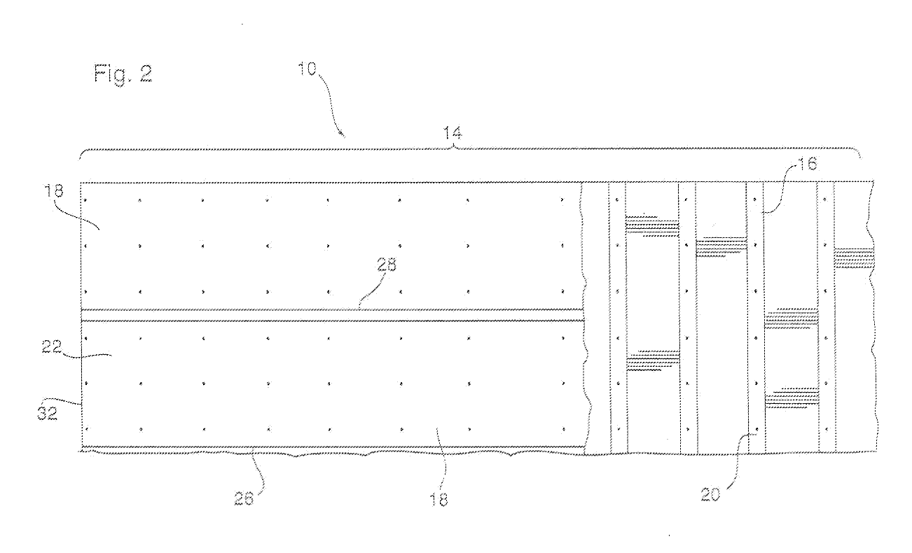

Referring now to FIGS. 1 and 2, a standard flatbed trailer, globally denoted by numeral 10, having a chassis 12 and a deck 14 is schematically illustrated in FIG. 1. The deck 14 provides for a plurality of supports 16 transversally oriented relative to the longitudinal axis of the chassis 12 as is conventional.

In this embodiment, a series of flooring members 18 in accordance with the present invention are shown attached to the deck 14 and particularly the supports 16. Attachment is achieved by making use of suitable fasteners (not shown) which are received by registering apertures 20 in the supports 16 and apertures 22 in the flooring members 18.

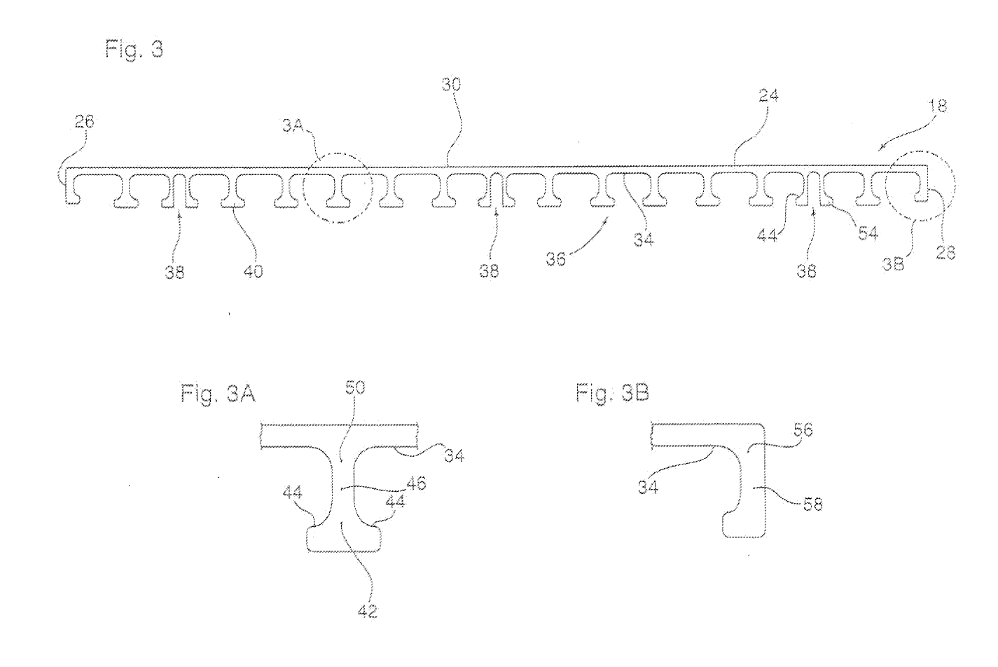

With reference to FIGS. 2 and 3 through 3B, greater detail is set forth for the flooring members 18. Structurally, the member 18, comprises a unitary pultruded resinous flat panel having a flat top surface 24, opposed sides 26 and 28 and opposed edges 30 and 32. An under surface 34 has a plurality of spaced apart support legs depending there from, generally referenced by numeral by numeral 36. In a predetermined distance, based on strength, there are provided fastener receiving channels 38, extending longitudinally of the member 18. The transverse distance between channels 38 will depend on the overall size of the flooring member 18, however, generally a channel will be provided proximate the sides 26 and 28 and approximately centrally. The channels each are bounded by the under surface 34 of the member 18 and supporting legs 40.

Turning to the supporting legs 40, the same have been designed to provide high strength under the excessive loads the members typically encounter. In the embodiment shown, the legs 40 have a planar contact surface or foot 42 with shoulders 44 merging with the straight segment 46 of the leg 40. Segment 46 merges with the under surface 34 in a concave radial disposition having a radius of curvature of between 5 mm and 10 mm. It has been found that the radius of curvature within this range is most effective in terms of strength, mass and overall performance.

The radial disposition affords a greater amount of resin material to be provided at the point of merger with the straight segment 46 and under surface 34 relative to that which is provided for the straight segment 46. Referral to FIG. 3A illustrates this structural relationship. This is an important feature since significant compressive loads must be supported. It has been found that this relationship provides a significant improvement over those designs where the width dimension is invariable. Given that the top surface 30 of the member 18 is exposed to large compressive forces, the load bearing members thus become the legs 40 with a predominant amount of the load translated to the straight segments 46. In this manner, the overall profile is loosely similar to a beam bridge.

In terms of other dimensions and features, the widest areas of the segments 46 are where the onset of curvature begins, namely 50 and 52. These are substantially equivalent in width and may vary in area between equivalency to area 52 being up to 20% greater in width than that of 50. This will, of course, vary depending upon the specific requirements for the member 18.

Returning to fastener receiving channels 38, as noted supra the same are bounded legs 40 and undersurface 34. The legs 40 are modified in structure relative to the other legs 40 in the member 18. The legs 40 include partial feet 54 which, when placed together, comprise a size comparable to feet 42. The shoulder 44 exists for each partial foot as does the radius of curvature as discussed herein previously.

FIG. 3B provides enlarged detail for the opposed sides 26 and 28, with side 28 being illustrated. The radius of curvature described with respect to FIG. 3A is also applicable to the radial arrangement of the side of member 18. The area denoted with numeral 56 has the maximum width relative to the straight segment 58.

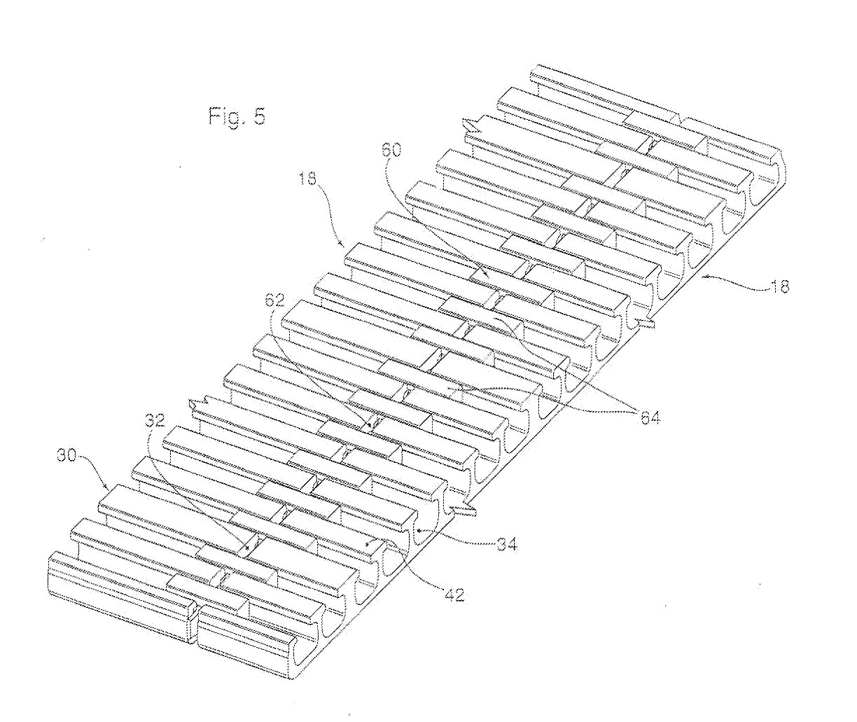

FIG. 4 is a schematic illustration of the container having the flooring and attached to container 55, such as those manufactured by the CIMC Company, mentioned supra.

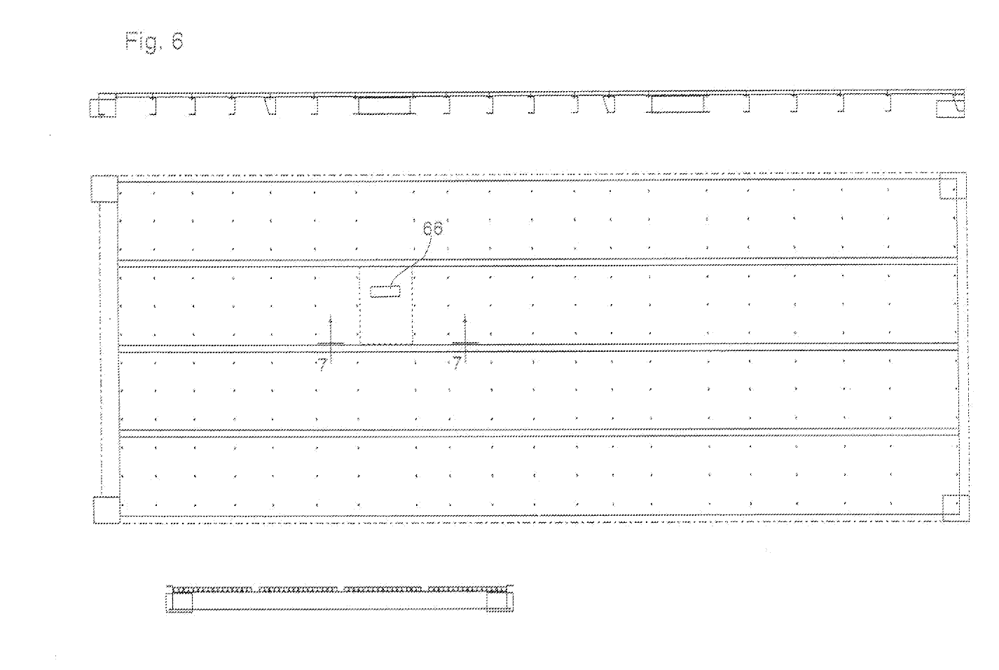

In FIG. 5 there is shown a connection member 60 for repairing damaged sections of the flooring member(s) 18. The member 60 has a longitudinal segment 62 and a plurality of transversely oriented spaced apart and coaxially aligned members 64. Between adjacent members 64 there is a space to receive, inter digitally, legs 40 of the flooring member 18.

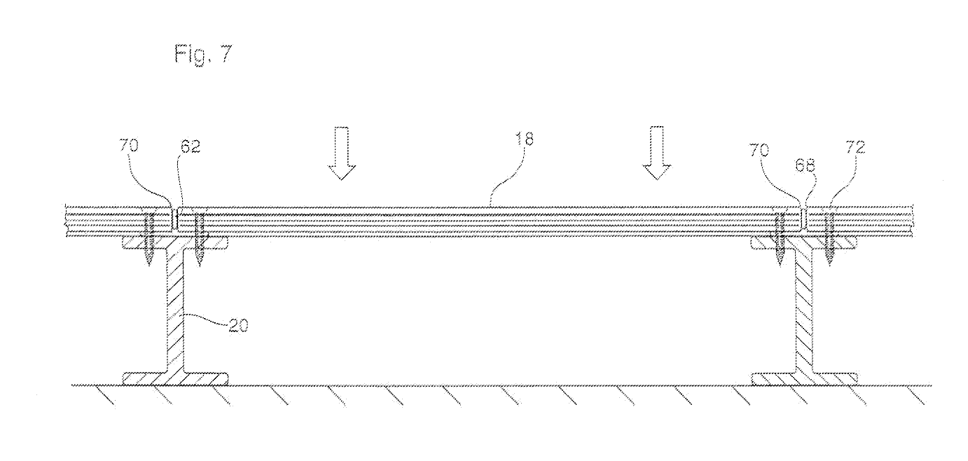

With reference to FIGS. 6 and 7, a damaged area 66, as shown in FIG. 6, can simply be cut out as shown in dotted line between adjacent supports 16 and discarded. A new section of flooring 18 cut to size can then be positioned in the same area. The damaged area 66 has a leading edge 68 and a trailing edge 70 between which the new section of flooring 18 is placed. The replaced flooring may then be secured to the supports 20 with, for example fasteners 72 extending through the flooring 18, connection member 60 and support 20.

Numerous advantages are realized by this arrangement. First, the inter digital fit of member 60 and the longitudinal body permits fastener connection at any point along the width of the replaced floor section and thus old apertures do not need to be re-used. Second, the maximum amount of floor 18 which needs to be removed for any damaged area is the area between adjacent supports. Further, the entire width of the original panel does not need to be removed, but rather only the width of the damaged area. This prevents costly wastage conventional in wood flooring systems where the removed area must span at least three supports and the width of the panel, regardless of the size of the damaged area.

Identification of repaired areas can be determined by sealant lines 72.

Although a panacea of suitable choices exist for the material of which the member 18 can be made, it is desirably polyurethane resin. This resin offers superior performance in terms of strength and toughness. Previously employed materials for pultrusion included vinyl esters, rubber polymers, phenolic resins. These materials, although useful in some applications, do not offer the requisite strength to support, for example, a forklift under load. The existing materials, in some cases, become brittle when exposed to temperature fluctuations which can lead to weakness and subsequent failure under load.

It has been found that the resin is desirably a two component liquid polyurethane resin system based on diphenylmethane diisocyanate and blended polyether or polyester polyols. As an alternative, a hybrid polyurethane resin comprising both polyurethane and polyester functionality may be used. In respect of the reinforcement used in the pultrusion, high strength glass or basalt fibres arranged as rovings, mats or braids may be used.

From a process point of view, the process essentially follows the conventional steps associated with a pultrusion process.

Having thus described the various embodiments of the invention, data are now presented evincing the advantages of the structure of the present invention.

TABLE 1
COMPOSITE MATERIAL PROPERTY COMPARISONS

| | | | Vinyl | |
|---|---|---|---|---|
| | PUR | Hybrid PUR | Ester | Polyester |
| Strength Loss After Salt Water Immersion | lowest | moderate | moderate | highest |
| Impact Strength Improvement Relative to Polyester | +34% | +15% | +7% | — |
| Tensile Strength Relative to Polyester (longitudinal) | +158% | n/a | +14% | — |
| Tensile Strength Relative to Polyester (transverse) | +300% | n/a | +7% | — |
| Tensile Modulus Relative to Polyester (longitudinal) | +124% | n/a | +20% | — |
| Tensile Modulus Relative to Polyester (transverse) | +50% | n/a | +25% | — |
| Compressive Strength Relative to Polyester (longitudinal) | +36% | n/a | +14% | — |
| Compressive Strength Relative to Polyester (transverse) | +82% | n/a | +21% | — |
| Compressive Modulus Relative to Polyester (longitudinal) | +37% | n/a | 0 | — |
| Compressive Modulus Relative to Polyester (transverse) | +220% | n/a | +20% | — |
| Flexural Strength Relative to Polyester (longitudinal) | +158% | n/a | +14% | — |
| Flexural Strength Relative to Polyester (transverse) | +445% | n/a | +14% | — |
| Flexural Modulus Relative to Polyester (longitudinal) | +81% | n/a | +25% | — |
| Flexural Modulus Relative to Polyester (transverse) | +150% | h/a | +25% | — |
| Bearing Strength Relative to Polyester (longitudinal) | +43% | +39% | +23% | — |
| Bearing Strength Relative to Polyester (transverse) | +45% | +21% | +25% | — |

TABLE 2
INFLUENCE OF RADII ON RIB SECTION PROPERTIES

Radius

| Section Property | Units | 3.5 mm | 7 mm |
|---|---|---|---|
| Principal Moment of Inertia | mm⁴ | 57692 | 59030 |
| von Mises Stress Reduction | % | — | 17-26 |

In respect of Table 1, it is evident that both the polyurethane resin and the hybrid polyurethane resin both have significant impact strength improvement relative to polyester with the polyurethane resin showing a 34% increase in impact strength relative to polyester and the hybrid showing a 15% increase. Perhaps one of the most impressive increases in strength is the compressive modulus of the PUR relative to polyester. As a further point, the bearing strength in the longitudinal and transverse directions is obviously superior to vinyl esters; of particular noteworthiness the increase that the PUR of material provides.

As noted previously in the discussion concerning materials and particularly the highlighting the difference between the hardwoods and the resin material forming part of the instant invention, the increase in compressive strength, bearing strength and the other physical characteristics noted in table 1 are important to ensure long life and durability of the flooring material. By the materials chosen and indicated for use in the instant mention, it is clear that these provide superior properties over other polymers noted and most certainly over natural material such as hardwoods.

In respect of the radius of curvature to provide for the additional material at the joinder or joining of the leg to the under surface of the flooring material, it is evident that the von Mises stress reduction is very significant as the radius increases. The data is shown as a 7 millimetre radius of curvature showing a stress reduction in the range of between 17 to 26%.

In an alternative embodiment, the flooring set forth herein may be directly bonded to a supporting structure thus avoiding fasteners entirely.

1. A flooring member, comprising:
a one piece fibre reinforced polymeric body having a top surface an underside, opposed edges and opposed sides;
a plurality of spaced apart dependent supporting legs for contact with a substrate, each said leg having a segment orthogonally disposed relative to said top surface; and
a contact surface at a terminal point of said segment, said surface for contacting said substrate in spaced relation to a point of connection with said underside, said segment merging to said point of connection in a concave radial disposition to form a point of contact wider than a width dimension of said segment.

2. The flooring member as set forth in claim 1, wherein said polymeric body comprises a polyurethane resin.

3. The flooring member as set forth in claim 1, wherein said polyurethane resin comprises a member selected from the group consisting of diphenylmethane diisocyanate and blended polyether, diphenylmethane diisocyanate and blended polyester polyols, and hybrid polyurethane resin having polyurethane and polyester functionality.

4. The flooring member as set forth in claim 1, wherein said fibre of said fibre reinforced polymeric body is selected from the group consisting of high strength glass and basalt fibre.

5. The flooring member as set forth in claim 1, wherein said body further includes means for accommodating fasteners for fastening said member to said substrate.

6. The flooring member as set forth in claim 1, wherein said means for accommodating fasteners comprises a channel bounded by adjacent supporting legs and said under surface of said body, said channel dimensioned to receive a fastener.

7. The flooring member as set forth in claim 6, wherein said member includes a plurality of channels in a predetermined alternating sequence relative to the area dimensions of said member.

8. The flooring member as set forth in claim 1, wherein said top surface of said body is planar.

9. The flooring member as set forth in claim 1, wherein said top surface further includes a coating bonded thereto, said coating for providing wear resistance of said top surface.

10. The flooring member as set forth in claim 1, wherein said concave radial disposition has a radius of curvature of between 5 mm and 10 mm.

11. A container, comprising, in combination:
a body having a top, spaced apart sides, a back and a front spaced there from and an open bottom having support means in transverse relation relative to said sides, at least one of said sides, back and front, being movable to permit access to said container;
a flooring member having a one piece polymeric body with a top surface an underside, opposed edges and opposed sides; and
a plurality of spaced apart dependent supporting legs for contact with said support means, each said leg having a segment orthogonally disposed relative to said top surface, a contact surface at a terminal point of said segment, said surface for contacting said support means in spaced relation to a point of connection with said underside, said segment merging to said point of connection in a concave radial disposition to form a point of contact wider than a width dimension of said segment, said flooring member being attached thereto.

12. The combination as set forth in claim 11, wherein said container comprises a shipping container.

13. The combination as set forth in claim 11, wherein said polyurethane resin has a polyether backbone.

14. The combination as set forth in claim 11, wherein said polyurethane resin has a polyester backbone.

15. The flooring member of claim 1, in combination with a vehicle having a load receiving section with support members for receiving said contact surface of each leg of said legs.

16. The combination as set forth in claim 12, including a vehicle for securely retaining said shipping container.

17. A connection member for connecting adjacent sections of flooring, said flooring having a unitary polymeric body having a top surface an underside, opposed edges and opposed sides;
a plurality of spaced apart dependent supporting legs for contact with a substrate, each said leg having a segment orthogonally disposed relative to said top surface; and
a contact surface at a terminal point of said segment, said surface for contacting said substrate in spaced relation to a point of connection with said underside, said connection member having a longitudinal segment and a plurality of transversely oriented members coaxially arranged in spaced relation along said longitudinal segment, said members-arranged to define between adjacent members for inter digital connection with said supporting legs.

18. The connection member as set forth in claim 17, wherein said connection member comprises polyurethane resin.

19. A method for repairing synthetic modular flooring attached to a substrate, said flooring having a top surface an underside, opposed edges and opposed sides;
a plurality of spaced apart dependent supporting legs for contact with said substrate, each said leg having a segment orthogonally disposed relative to said top surface;
a contact surface at a terminal point of said segment, said surface in contact with said substrate in spaced relation to a point of connection with said underside, said substrate, having transverse supports relative to a longitudinal axis thereof comprising the steps of:
providing a connection member having a longitudinal segment and a plurality of transversely oriented members coaxially arranged in spaced relation along said longitudinal segment, said members arranged to define space between adjacent members for inter digital connection with said supporting legs;
removing a damaged section of said flooring to leave a leading edge and a trailing edge in an opening from a removed section;
positioning a connection member adjacent each of said leading edge and a trailing edge;
positioning a section of said flooring in said opening with said supporting legs inter digitally connected with said space between adjacent transverse members; and
securing said connection member and said section of said flooring to said transverse supports of said substrate.
